(19) United States
(12) Patent Application Publication
(10) Pub. No.: US 2004/0174721 A1
(43) Pub. Date: Sep. 9, 2004

(54) Switching power supply unit

(75) Inventor: Junichi Yamamoto, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/791,235

(22) Filed: Mar. 2, 2004

(30) Foreign Application Priority Data
Mar. 5, 2003 (JP) 2003-058990

(51) Int. Cl. H02M 3/335

(52) U.S. Cl. 363/19

(57) ABSTRACT

A switching power supply unit includes a transformer, a switching circuit disposed on a primary side of the transformer, a self-driven type synchronous rectifier circuit disposed on a secondary side of the transformer and including a rectifier switch, and a self-oscillation stop circuit disposed on the secondary side of the transformer and adapted to turn off the rectifier switch when a voltage between opposite ends of the rectifier switch exceeds a predetermined value.

In the thus constituted switching power supply unit, it is possible to quickly stop self-oscillation of a self-driven type synchronous rectifier circuit without using an isolated element such as a photo-coupler or the like.

### BACKGROUND OF THE INVENTION

The present invention relates to a switching power supply unit and particularly, to a switching power supply unit which can quickly stop self-oscillation of a self-driven type synchronous rectifier circuit without using an isolated element such as a photo-coupler or the like.

### DESCRIPTION OF THE PRIOR ART

The switching power supply unit has been widely used as a power supply for computers and other electronic and electrical equipment.

FIG. 3 is a circuit diagram of a conventional switching power supply unit. The conventional switching power supply unit shown in FIG. 3 is adapted for transforming an input voltage Vi fed across a pair of input terminals 1, 2 from a direct current input power source to generate an output voltage Vo and feeding the output voltage Vo to a load connected between a pair of output terminals 3, 4 and includes a transformer T1, a switching circuit 10 provided on the primary side of the transformer T1 and an output circuit 20 provided on the secondary side of the transformer T1.

The switching circuit 10 includes an input capacitor Ci connected between the pair of input terminals 1, 2 and a main switch Q1 connected between one end of a primary winding Lp of the transformer T1 and the input terminal 2. The main switch Q1 is PWM controlled by a control circuit 30.

The output circuit 20 includes a rectifier switch Q2 connected to one end of a secondary winding Ls of the transformer T1 and the output terminal 4, a rectifier switch Q3 connected to the other end of the secondary winding Ls of the transformer T1 and the output terminal 4, a rectifier diode CR2 connected in parallel with the rectifier switch Q2, a rectifier diode CR3 connected in parallel with the rectifier switch Q3, a choke coil Lo connected to the other end of the secondary winding Ls of the transformer T1 and the output terminal 3, and a smoothing capacitor Co connected to the pair of output terminals 3, 4. The gate of the rectifier switch Q2 is connected to the other end of the secondary winding Ls of the transformer T1 and the gate of the rectifier switch Q3 is connected to the one end of the secondary winding Ls of the transformer T1, whereby the rectifier switch Q2 and the rectifier diode CR2, and the rectifier switch Q3 and the rectifier diode CR3 constitute a self-driven type synchronous rectifier circuit. The choke coil Lo and the smoothing capacitor Co constitute a smoothing circuit.

As shown in FIG. 4, the load 6 can be represented by a resistance component RLoad, a capacitor component CLoad and a reactor component Lload.

The control circuit 30 monitors the output voltage Vo and lowers the on-duty factor of the main switch Q1 as the output voltage Vo becomes higher than a target voltage, thereby decreasing electric power supplied to the load 6. On the other hand, the control circuit 30 increases the on-duty factor of the main switch Q1 as the output voltage Vo becomes lower than the target voltage, thereby increasing power supplied to the load 6. Thus, the output voltage Vo supplied to the load 6 is controlled to be equal to the target voltage.

During a period when the main switch Q1 is on, the rectifier switch Q2 is turned on and the rectifier switch Q3 is turned off by a voltage generated in the secondary winding Ls of the transformer T1. On the other hand, during a period when the main switch Q1 is off, the rectifier switch Q2 is turned off and the rectifier switch Q3 is turned on by a reverse polarity voltage generated in the secondary winding Ls of the transformer T1. Therefore, the rectifier switches Q2 and Q3 are alternately turned on or off in synchronism with the on and off operation of the main switch Q1. As a result, a voltage on the secondary side of the transformer T1 is rectified and then smoothed by the smoothing circuit constituted by the choke coil Lo and the smoothing capacitor Co to be supplied across the output terminals 3, 4 as an output voltage Vo.

However, when the switching operation of the main switch Q1 is shut down by the user, for example, one of the rectifier switches Q2 and Q3 is kept on, thereby triggering self-oscillation of the synchronous rectifier circuit. The self-oscillation continues until the power of the smoothing capacitor Co and the power of the capacitor component CLoad of the load 6 has been consumed by the resistance component RLoad of the secondary circuit of the transformer T1 and the load 6, whereby the output voltage Vo decreases while continuing to oscillate at a much longer cycle than the ordinary switching cycle. Therefore, in the case where, for example, the load 6 is adapted to judge that the switching power supply has shut down and operate in a predetermined manner when the output voltage Vo decreases to or below a predetermined value, the fact that the output voltage Vo decreases while continuing to oscillate makes it difficult for the load 6 to judge whether or not the switching power supply unit has shut down.

Further, when the self-oscillation of the synchronous rectifier circuit occurs, since large current flows through the choke coil Lo, the secondary winding Ls of the transformer T1 and the rectifier switches Q2 and Q3, much heat is generated in the choke coil Lo, the secondary winding Ls of the transformer T1 and the rectifier switches Q2 and Q3. The reliability of the switching power supply unit is therefore liable to be degraded.

Since the above problems caused by the self-oscillation of the synchronous rectifier circuit become more serious as the resistance component RLoad of the load 6 becomes larger, they are particularly serious when the switching power supply unit is shut down at a light load, for example. Further, since the problems caused by the self-oscillation of the synchronous rectifier circuit become more serious as the capacitor component CLoad of the load 6 becomes larger, they are particularly serious when power is supplied to a load having a large capacitor component CLoad.

The self-oscillation of the synchronous rectifier circuit can be prevented by shutting off at least one of the rectifier switches Q2 and Q3 in response to shutdown of the switching power supply unit. Japanese Patent Application Laid Open No. 2002-233144, for example, discloses a switching power supply unit constituted so as to shut off at least one of rectifier switches Q2 and Q3 in response to shutdown of the switching power supply unit.

FIG. 5 is a circuit diagram of the switching power supply unit shown in FIG. 1 of Japanese Patent Application Laid Open No. 2002-233144 and FIG. 6 is a circuit diagram of the switching power supply unit shown in FIG. 2 thereof.

The switching power supply unit shown in FIG. 5 includes a photo-coupler 7 for informing the secondary side of shutdown of the switching power supply unit and a transistor 8 that has its base connected to the collector of a light receiving side element 7b of the photo-coupler 7 and that is adapted to short-circuit the gate and source of the rectifier switch Q3 when the light receiving side element 7b turns off. A light emitting side element 7a emits light during the period when gate pulses are being supplied to the main switch Q1 and does not emit light when no gate pulse is supplied to the main switch Q1. Since the gate and source of the rectifier switch Q3 is short-circuited when the light receiving side element 7b of the photo-coupler 7 turns off in response to shutdown of the switching operation, self-oscillation of the synchronous rectifier circuit can be prevented.

On the other hand, the switching power supply unit shown in FIG. 6 includes a transistor 9 connected between the gate of a rectifier switch Q3 and a choke coil Lo for generating gate pulses, and the collector of a light receiving side element 7b of a photo-coupler 7 is connected to the base of the transistor 9. Therefore, when the light receiving side element 7b of the photo-coupler 7 turns off in response to shutdown of the switching operation, the gate of the rectifier switch Q3 is cut off from the choke coil Lo for generating gate pulses to thereby prevent self-oscillation of the synchronous rectifier circuit.

However, in each of the switching power supply units shown in FIGS. 5 and 6, since the shutdown of the switching operation is detected on the primary side, an isolated element such as a photo-coupler or the like is necessary. This makes the circuit configuration complex and increases cost.

In particular, in the switching power supply unit shown in FIG. 6, since the collector of the light receiving side element 7b of the photo-coupler 7 is connected to the choke coil Lo, the voltage between the collector and emitter of the light receiving side element 7b normally oscillates at a high frequency. Since the light receiving side element of a photo-coupler is generally constituted as a transistor having high gain, current is supplied from the collector to the base when a sharp voltage is applied to the collector of the light receiving side element 7b even if the light emitting side element is off, whereby the light receiving side element 7b is easily turned on. This is particularly true at a high temperature because the current supplied from the collector to the base increases when the temperature is high. When the voltage between the collector and emitter of the light receiving side element 7b is oscillating, therefore, the light receiving side element may fail to turn off or take a long time to turn off in response to turn-off of the light emitting side element. Accordingly, in the switching power supply unit shown in FIG. 6, it is necessary to employ a photo-coupler which can be reliably turned off under the above conditions. Even when a photo-coupler having such a characteristic is employed, however, the self-oscillation of the synchronous rectifier circuit cannot be stopped for some time after the shutdown of the switching operation.

### SUMMARY OF THE INVENTION

It is therefore an object of the present invention to provide a switching power supply unit which can quickly stop self-oscillation of a self-driven type synchronous rectifier circuit without using an isolated element such as a photo-coupler or the like.

The above and other objects of the present invention can be accomplished by a switching power supply unit comprising a transformer, a switching circuit disposed on a primary side of the transformer, a self-driven type synchronous rectifier circuit disposed on a secondary side of the transformer and including at least one rectifier switch, and a self-oscillation stop circuit disposed on the secondary side of the transformer and adapted to turn off the at least one rectifier switch when a voltage between opposite ends of the at least one rectifier switch exceeds a predetermined value.

According to the present invention, since self-oscillation of the synchronous rectifier circuit is detected based on the voltage between opposite ends of the at least one rectifier switch and the at least one rectifier switch is turned off, it is possible to quickly stop the self-oscillation of the synchronous rectifier circuit without using an isolated element such as a photo-coupler or the like. Therefore, it is possible to stop the self-oscillation of the synchronous rectifier circuit with a simpler circuit configuration than that of a conventional switching power supply unit.

In a preferred aspect of the present invention, the self-oscillation stop circuit further includes a Zener diode connected in parallel with the at least one rectifier switch.

In a further preferred aspect of the present invention, a Zener voltage of the Zener diode is determined so as to be higher than a voltage applied between the opposite ends of the at least one rectifier switch during ordinary operation.

In a further preferred aspect of the present invention, the Zener voltage of the Zener diode is determined so as to be lower than a withstand voltage of the at least one rectifier switch.

According to these preferred aspects of the present invention, since the voltage between the opposite ends of the at least one rectifier switch can be detected using the Zener diode, it is possible to easily and reliably detect self-oscillation of the synchronous rectifier circuit.

In a further preferred aspect of the present invention, the self-oscillation stop circuit is constituted so as to turn off the at least one rectifier switch by substantially short-circuiting a gate and a source of the at least one rectifier switch.

The above and other objects and features of the present invention will become apparent from the following description made with reference to the accompanying drawings.

### BRIEF DESCRIPTION OF THE DRAWINGS

FIG. 1 is a circuit diagram of a switching power supply unit which is a preferred embodiment of the present invention.

FIG. 2 is a diagram showing circuits on the secondary side of a transformer in a switching power supply unit which is another preferred embodiment of the present invention.

FIG. 3 is a circuit diagram of a conventional switching power supply unit.

FIG. 4 is an equivalent circuit diagram of a load shown in FIG. 3.

FIG. 5 is a circuit diagram showing another example of a conventional switching power supply unit.

FIG. 6 is a circuit diagram showing a further example of a conventional switching power supply unit.

### DESCRIPTION OF THE PREFERRED EMBODIMENTS

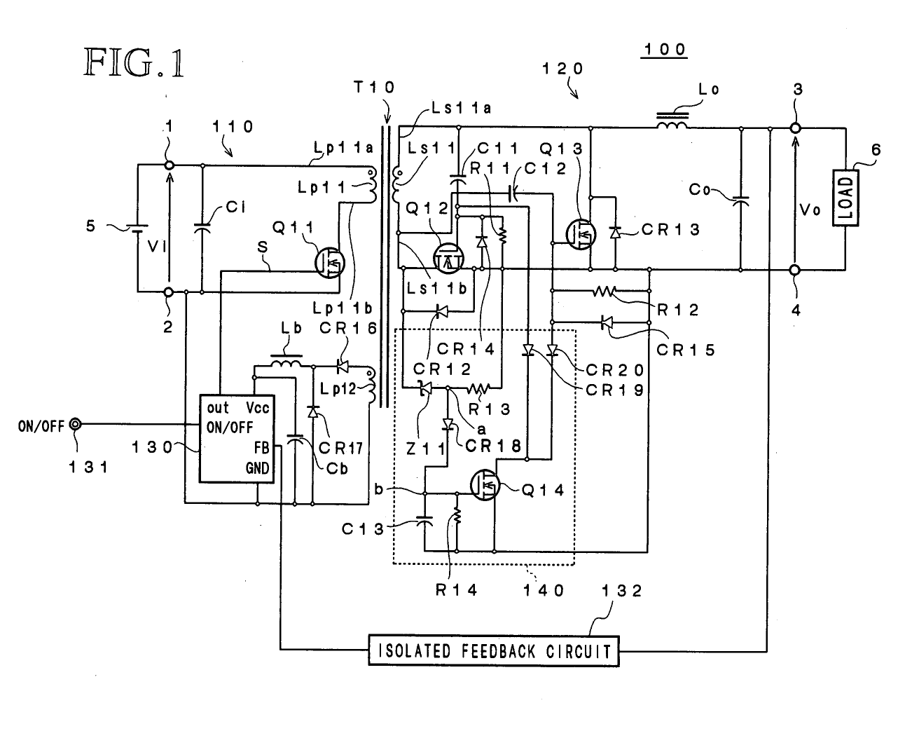

FIG. 1 is a circuit diagram of a switching power supply unit which is a preferred embodiment of the present invention.

As shown in FIG. 1, the switching power supply unit 100 according to this embodiment is constituted so as to transform an input voltage Vi supplied from a direct current input source 5 across a pair of input terminals 1, 2 to generate an output voltage Vo and feed the output voltage Vo to a load 6 connected across a pair of output terminals 3, 4 and includes a transformer T10, a switching circuit 110 disposed on the primary side of the transformer T10, an output circuit 120 disposed on the secondary side of the transformer T10, a control circuit 130 for controlling the operation of the switching circuit 110 and a self-oscillation stop circuit 140 for controlling the operation of the output circuit 120.

The switching circuit 110 includes an input capacitor Ci connected across the pair of input terminals 1, 2 and a main switch Q11 connected between one end Lp11b of the primary winding Lp11 of the transformer T10 and the input terminal 2. The main switch Q11 is adapted to be PWM controlled by the control circuit 130. The other end Lp11a of the primary winding Lp11 is connected to the input terminal 1.

The output circuit 120 includes a rectifier switch Q12 connected between one end Ls11b of the secondary winding Ls11 of the transformer T10 and the output terminal 4, a rectifier switch Q13 connected between the other end Ls11a of the secondary winding Ls11 of the transformer T10 and the output terminal 3, a rectifier diode CR12 connected in parallel with the rectifier switch Q12, a rectifier diode CR13 connected in parallel with the rectifier switch Q13, a choke coil Lo connected between the other end Ls11a of the secondary winding Ls11 of the transformer T10 and the output terminal 3, and a smoothing capacitor Co connected between the pair of output terminals 3, 4.

The gate (control terminal) of the rectifier switch Q12 is connected to the other end Ls11a of the secondary winding Ls11 via a capacitor C11 and is also connected to the output terminal 4 via a parallel circuit consisting of a diode CR14 and a resistor R11. On the other hand, the gate (control terminal) of the rectifier switch Q13 is connected to the one end Ls11b of the secondary winding Ls11 via a capacitor C12 and is also connected to the output terminal 4 via a parallel circuit consisting of a diode CR15 and a resistor R12. Therefore, the secondary winding Ls11 serves as a source for generating gate (control) pulses supplied to the gates of the rectifier switches Q12 and Q13. Thus, the rectifier switch Q12 and rectifier diode CR12 and the rectifier switch Q13 and rectifier diode CR13 constitute a self-driven type synchronous rectifier circuit.

The choke coil Lo and the smoothing capacitor Co constitute a smoothing circuit.

In this embodiment, although an N-channel type field-effect transistor is employed as each of the main switch Q11 and the rectifier switches Q12 and Q13, another type of switching element or another type of switching circuit may be employed.

The control circuit 130 is constituted to be operated by a voltage supplied across a Vcc terminal and a GND terminal thereof from an auxiliary power source consisting of the primary winding Lp12 of the transformer T10, a diode CR16, a diode CR17, a choke coil Lb and a smoothing capacitor Cb. It is turned on or off in response to an ON signal or an OFF signal fed to an ON/OFF terminal thereof from a control terminal 131.

A feedback terminal FB of the control circuit 130 is supplied with a detection voltage from an isolated feedback circuit 132 for detecting the output voltage Vo. When the control circuit 130 is in operation, it responds to the detection voltage supplied to the feedback terminal FB by outputting PWM controlled gate pulses S from an output terminal out. The control circuit 130 decreases the duty factor of the gate pulses S as the output voltage increases above the target voltage, thereby decreasing the power supplied to the load 6 and, on the other hand, the control circuit 130 increases the duty factor of the gate pulses S as the output voltage decreases below than the target voltage, thereby increasing the power supplied to the load 6. Thus, the output voltage supplied to the load 6 is controlled to the target voltage.

The self-oscillation stop circuit 140 includes a Zener diode Z11 and a resistor R13 serially connected between the source and drain of the rectifier switch Q12, a diode CR18 and a capacitor 13 serially connected between a connection point a of the Zener diode Z11 with the resistor R13 and the output terminal 4, an N-channel type field-effect transistor Q14 whose gate is connected to a connection point b of the diode CR18 and with the capacitor C13 and whose source is connected to the output terminal 4, a diode CR19 connected between the gate of the rectifier switch Q12 and the drain of the N-channel type field-effect transistor Q14, a diode 20 connected between the gate of the rectifier switch Q13 and the drain of the N-channel type field-effect transistor Q14, and a resistor R14 connected between the gate and source of the field-effect transistor Q14. The resistor R14 is provided to prevent floating of the gate of the field-effect transistor Q14.

In ordinary operation, the Zener voltage of the Zener diode Z11 is determined to be higher than the voltage between the source and drain of the rectifier switch Q12 when the rectifier switch Q12 is off and lower than the withstand voltage between the source and drain of the rectifier switch Q12. Therefore, the Zener diode Z11 never turns on during ordinary operation and turns on only when a voltage that is excessively high (but lower than the withstand voltage) is applied between the source and drain of the rectifier switch Q12.

The thus constituted switching power supply unit operates as follows.

When the control circuit 130 is in operation, gate pulses S are supplied from the output terminal out to the main switch Q11 and the main switch Q11 is repeatedly turned on and off. During a period when the main switch Q11 is on, the rectifier switch Q12 is turned on and the rectifier switch Q13 is turned off by a voltage generated in the secondary winding Ls11 and, on the other hand, during a period when the main switch Q11 is off, the rectifier switch Q12 is turned off and the rectifier switch Q13 is turned on by a voltage having reverse polarity generated in the secondary winding Ls11. Therefore, the rectifier switches Q12 and Q13 are alternately turned on and off in synchronism with the on and off operation of the main switch Q11. As a result, the voltage on the secondary side of the transformer T10 is rectified and then smoothed by the smoothing circuit constituted by the choke coil Lo and the smoothing capacitor Co to be supplied across the output terminals 3, 4 as an output voltage Vo.

Since the Zener voltage of the Zener diode Z11 during ordinary operation is determined to be higher than the voltage between the source and drain of the rectifier switch Q12 when the rectifier switch Q12 is off, the Zener diode Z11 does not turn on during ordinary operation and, therefore, the voltages at the connection points a and b are substantially equal to zero. As a result, the field-effect transistor Q14 never turns on during ordinary operation.

To the contrary, when the control circuit 130 is off or when the output voltage becomes much higher than the target voltage for some reason, the switching operation of the main switch Q11 is stopped. As a result, one of the rectifier switches Q12 and Q13 remains on, thereby triggering self-oscillation of the synchronous rectifier circuit. During a period when the synchronous rectifier circuit is self-oscillating, the ON periods of the rectifier switches Q12 and Q13 increase, so that they draw current from the output capacitor Co and/or the load 6. When the amount of drawn-in current reaches saturation and the rectifier switch Q12 or Q13 turns off, a higher than usual voltage is applied between the source and drain of the rectifier switch Q12 or Q13. The voltage applied thereto gradually increases with the repetition of the self-oscillation of the synchronous rectifier circuit.

When, as a result, the voltage applied between the source and drain of the rectifier switch Q12 or Q13 comes to exceed the Zener voltage of the Zener diode Z11, the Zener diode Z11 turns on and current begins to flow through the resistor R13. Therefore, the voltages at the connection points a and b increase and when the voltage of the connection point b exceeds the threshold voltage of the field-effect transistor Q14, the field-effect transistor Q14 turns on. When the field-effect transistor Q14 turns on, the gate of the rectifier switch Q12 is connected to the source thereof via the diode C19 and the field-effect transistor Q14, and the gate of the rectifier switch Q13 is connected to the source thereof via the diode C20 and the field-effect transistor Q14. Therefore, the gate and source of each of the rectifier switches Q12 and Q13 is substantially short-circuited. Since both of the rectifier switches Q12 and Q13 are therefore turned off, the self-oscillation of the synchronous rectifier circuit is stopped.

As described above, in this embodiment, since the voltage between the source and drain of the rectifier switch Q12 is detected using the self-oscillation stop circuit 140 disposed on the secondary side of the transformer T10 and the rectifier switches Q12 and Q13 are turned off when the detected voltage becomes higher than the usual voltage, it is possible to quickly stop the self-oscillation of the synchronous rectifier circuit without using an isolated element such as a photo-coupler or the like. Therefore, it is possible to stop the self-oscillation of the synchronous rectifier circuit with a simpler circuit configuration than that of a conventional switching power supply unit.

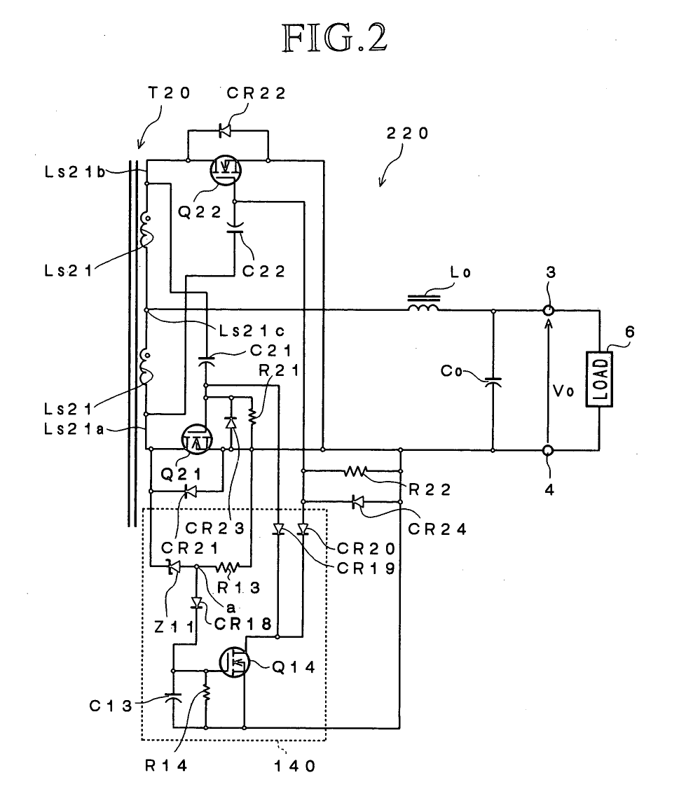

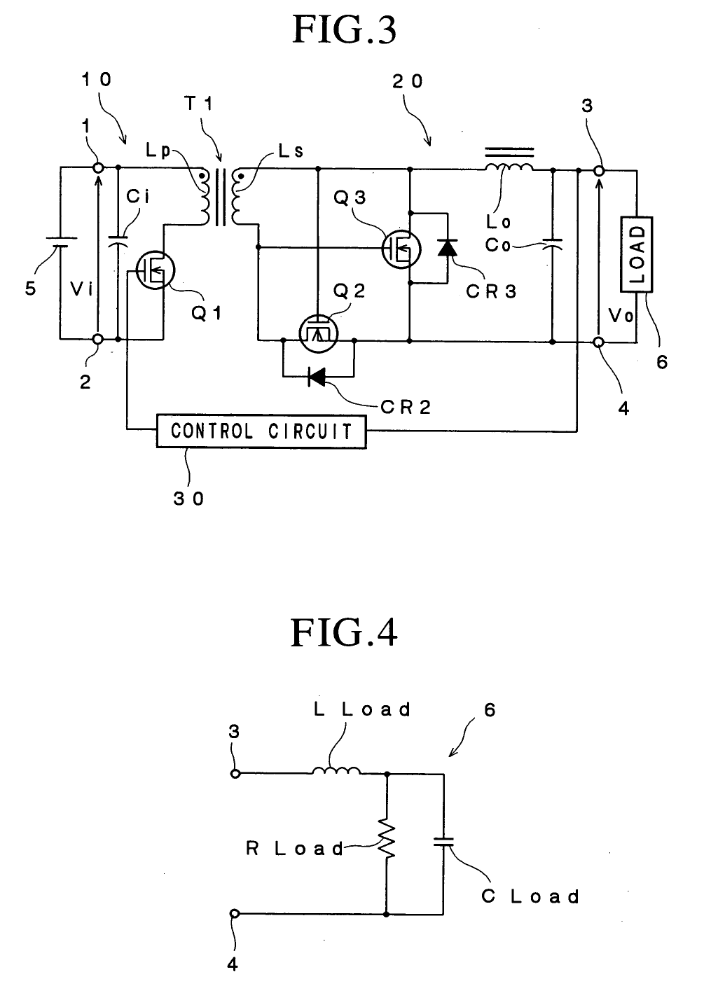

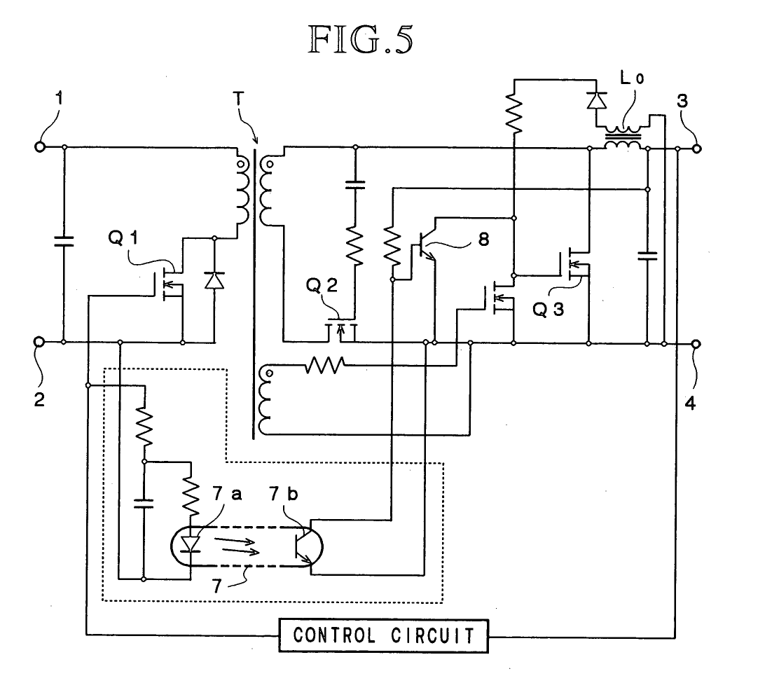

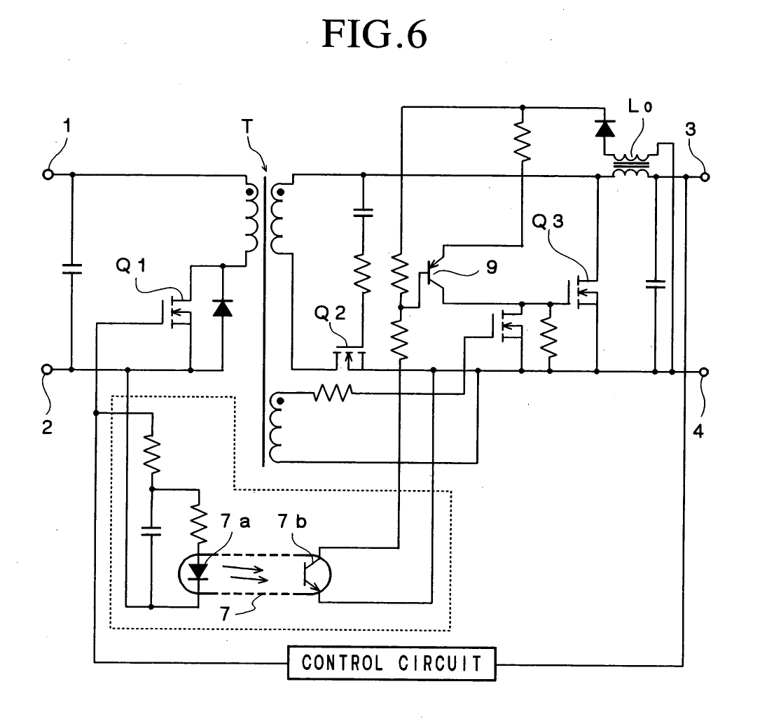

FIG. 2 is a diagram showing the circuits on the secondary side of a transformer in a switching power supply unit which is another preferred embodiment of the present invention. The switching power supply unit has the secondary side of the transformer constituted as a center-tap type. In FIG. 2, circuits belonging to the primary side of the transformer such as the switching circuit, control circuit and the like and the isolated feedback circuit are omitted for simplification.

An output circuit 220 shown in FIG. 2 includes a rectifier switch Q21 connected between one end Ls21a of a secondary winding Ls21 of a transformer T20 and an output terminal 4, a rectifier switch Q22 connected between the other end Ls21b of the secondary winding Ls21 of the transformer T20 and the output terminal 4, a rectifier diode CR21 connected in parallel with the rectifier switch Q21, a rectifier diode CR22 connected in parallel with the rectifier switch Q22, a choke coil Lo connected between the center tap Ls21c of the secondary winding Ls21 and an output terminal 3, and a smoothing capacitor Co connected between the output terminals 3, 4.

The gate (control terminal) of the rectifier switch Q21 is connected to the other end Ls21b of the secondary winding Ls21 via a capacitor C21 and is connected to the output terminal 4 via a parallel circuit consisting of a diode CR23 and a resistor R21. On the other hand, the gate (control terminal) of the rectifier switch Q22 is connected to the one end Ls21a of the secondary winding Ls21 via a capacitor C22 and connected to the output terminal 4 via a parallel circuit consisting of a diode CR24 and a resistor R22. Therefore, the secondary winding Ls21 serves as a source for generating gate pulses (control pulses) to be supplied to the gates of the rectifier switches Q21 and Q22. The rectifier switch Q21 and rectifier diode CR21, and the rectifier switch Q22 and rectifier diode CR22 constitute a self-driven type synchronous rectifier circuit.

In this embodiment, although an N-channel type field-effect transistor is employed as each of the rectifier switches Q21 and Q22, another type of switching element or another type of switching circuit may be employed.

In this embodiment, self-oscillation of the synchronous rectifier circuit can be quickly stopped by providing a self-oscillation stop circuit 140 as shown in FIG. 2 and substantially short-circuiting the gate and source of each of the rectifier switches Q21 and Q22 when the voltage between the source and drain of the rectifier switch Q21 exceeds the Zener voltage of the Zener diode Z11 due to the self-oscillation of the synchronous rectifier circuit.

The present invention has thus been shown and described with reference to specific embodiments. However, it should be noted that the present invention is in no way limited to the details of the described arrangements but changes and modifications may be made without departing from the scope of the appended claims.

For example, in the embodiment shown in FIG. 1, although explanation was made as to a forward-converter type switching power supply unit, the present invention can be applied to any of various types of switching power supply units including a self-driven type synchronous rectifier circuit on the secondary side of a transformer.

Further, in the above described embodiments, when the self-oscillation of the synchronous rectifier circuit is detected, both of the rectifier switches constituting the synchronous rectifier circuit are turned off. However, it is not absolutely necessary to turn off both of the rectifier switches constituting the synchronous rectifier circuit when the self-oscillation is detected, and it is sufficient to turn off only one of them.

Furthermore, in the above described embodiments, the self-oscillation of the synchronous rectifier circuit is detected based on the voltage between the source and drain of one of the rectifier switches among the two rectifier switches constituting the synchronous rectifier circuit. However, it is possible to detect the voltage between the source and drain of each of the rectifier switches and turn off one or both of the rectifier switches when the voltage between the source and drain of one of the rectifier switches exceeds a prescribed voltage.

Moreover, in the above described embodiments, the Zener diode is connected in parallel with the rectifier switch and the voltage between the source and drain of the rectifier diode, thereby detecting the self-oscillation of the synchronous rectifier circuit. However, it is not absolutely necessary to detect the voltage between the source and drain of the rectifier diode in this manner and another method may be used for detecting the voltage between the source and drain of the rectifier diode, although the self-oscillation of the synchronous rectifier circuit can be easily and reliably detected by employing a Zener diode.

Further, in the above described embodiments, although a diode is connected between the gate and source of each of the rectifier switches, these diodes may be omitted.

Furthermore, in the above described embodiments, although field-effect transistors used as the switching elements, it is not absolutely necessary to use field-effect transistors and another type of switching element can be used.

According to the present invention, it is possible to provide a switching power supply unit which can quickly stop self-oscillation of a self-driven type synchronous rectifier circuit without using an isolated element such as a photo-coupler or the like.

1. A switching power supply unit comprising a transformer, a switching circuit disposed on a primary side of the transformer, a self-driven type synchronous rectifier circuit disposed on a secondary side of the transformer and including at least one rectifier switch, and a self-oscillation stop circuit disposed on the secondary side of the transformer and adapted to turn off the at least one rectifier switch when a voltage between opposite ends of the at least one rectifier switch exceeds a predetermined value.

2. A switching power supply unit in accordance with claim 1, which further comprise a Zener diode connected in parallel with the at least one rectifier switch.

3. A switching power supply unit in accordance with claim 2, wherein a Zener voltage of the Zener diode is determined so as to be higher than a voltage applied between the opposite ends of the at least one rectifier switch during ordinary operation.

4. A switching power supply unit in accordance with claim 3, wherein the Zener voltage of the Zener diode is determined so as to be lower than a withstand voltage of the at least one rectifier switch.

5. A switching power supply unit in accordance with claim 1, wherein the self-oscillation stop circuit is constituted so as to turn off the at least one rectifier switch by substantially short-circuiting a gate and a source of the at least one rectifier switch.

6. A switching power supply unit in accordance with claim 2, wherein the self-oscillation stop circuit is constituted so as to turn off the at least one rectifier switch by substantially short-circuiting a gate and a source of the at least one rectifier switch.

7. A switching power supply unit in accordance with claim 3, wherein the self-oscillation stop circuit is constituted so as to turn off the at least one rectifier switch by substantially short-circuiting a gate and a source of the at least one rectifier switch.

8. A switching power supply unit in accordance with claim 4, wherein the self-oscillation stop circuit is constituted so as to turn off the at least one rectifier switch by substantially short-circuiting a gate and a source of the at least one rectifier switch.
